(19) United States
(12) Patent Application Publication
(10) Pub. No.: US 2008/0029622 A1
(43) Pub. Date: Feb. 7, 2008

(54) Device and System for Transforming Liquids Having Different Viscosity into Droplets

(76) Inventor: Rainer Pommersheim, Mainz (DE)

Correspondence Address: BODNER & O'ROURKE, LLP, 425 BROADHOLLOW ROAD, SUITE 108, MELVILLE, NY, 11747, US

(21) Appl. No.: 10/590,386

(22) PCT Filed: Feb. 23, 2005
(86) PCT No.: PCT/EP05/01891

§ 371 Date: Jul. 26, 2007

(30) Foreign Application Priority Data
Feb. 24, 2004 (DE) 10 2004 009 385.7

(51) Int. Cl. B05B 7/06

(52) U.S. Cl. 239/424; 239/337; 239/346

(57) ABSTRACT

The invention relates to a device for transforming liquids having different viscosity into droplets. The inventive system is characterized by differently designed air nozzles which are devoid of moving parts. Due to its modular architecture the system can be operated with any of the nozzles and different individual components as required, which ensures a maximum flexibility.

The invention relates to a device for transforming liquids having different viscosity into droplets. The inventive system is characterized by differently designed air nozzles which are devoid of moving parts. Due to its modular architecture the system can be operated with any of the nozzles and different individual components as required, which ensures a maximum flexibility.

In technological practice it is frequently required to produce individual droplets from different liquids. The simplest and most widespread method to achieve this resides in spraying by means of suitable nozzles. Such nozzles are offered in commerce in a very large constructive variety. The range reaches from a simple spray head or lawn sprinkler to high-tech developments in the fields of mechanical engineering or paints and varnishes. All of these systems are constructed to produce a spray mist or at least a spray jet formed of innumerable droplets which can, however, neither be influenced individually nor can they be defined more closely.

However, if one wants to produce exactly defined droplets so as to obtain thereby spherical particles by means of chemical or physical hardening, the aforementioned systems are unusable due to their inaccuracy in view of the generated individual droplets. For such purposes systems are applied which are capable of producing precise liquid jets, which are disintegrated subsequently to form individual droplets of defined sizes.

In all of these systems the liquid jets are produced by pressing the liquid starting materials through capillary orifices. Differences merely occur in the methods by means of which these jets are separated into individual droplets.

The methods for this purpose may be classified in two large groups:
1. Methods, in which the liquid jet experiences in addition to its axial movement other movements, such as a rotation or vibration, and
2. Methods, in which the liquid jet experiences no additional movement except for its axial flow movement.

In the first category the jet is disintegrated by centrifugal forces or resonant vibrations, respectively, in the second one by the axial influence of additional media which are, as a rule, gaseous ones. The present invention belongs to the second group.

In technical literature systems serving the production of individual droplets from liquids can be found in numerous places. Only some of them shall be mentioned as examples below.

For example, F. Lim and A. Sun describe in the magazine “Science”, volume 210, pages 908-910, 1980, a method using capillaries at which the drop is separated by an air flow. Thus, one obtains capsule sizes between approximately 200 μm and approximately 2 mm with a very narrow size distribution. However, this publication primarily relates to a method for the encapsulation of cells; a complete laboratory apparatus for the production of droplets is not described therein.

Another method for the production of droplets is the one described in the German patent application 3836894 according to which several capillaries are caused to vibrate, which entails a separation of the liquid jets into individual droplets. In this case, too, the obtained capsules have diameters between approximately 200 μm and approximately 2 mm, while the productivity thereof is clearly higher than that of the above-mentioned nozzles, but with a much wider size distribution. Also, the system needs a readjustment for every new application.

All of these systems always only use a device for producing droplets which frequently also comprises moving parts. By this, the flexibility is strongly limited, or the expenditure for maintenance and handling increases.

On the basis of this prior art it is the object of the invention to provide a device which, for the first time, is capable due to its modular architecture of transforming liquids having a different viscosity into droplets in a large size range with a narrow distribution, without the aforementioned drawbacks. The individual components and the devices for the production of droplets are compatible such that they can be interchanged within the system.

According to the invention the device or the system are subdivided into two portions—the nozzle, which may have different designs, and the periphery with additional control components serving the supply of media and the control of the nozzle.

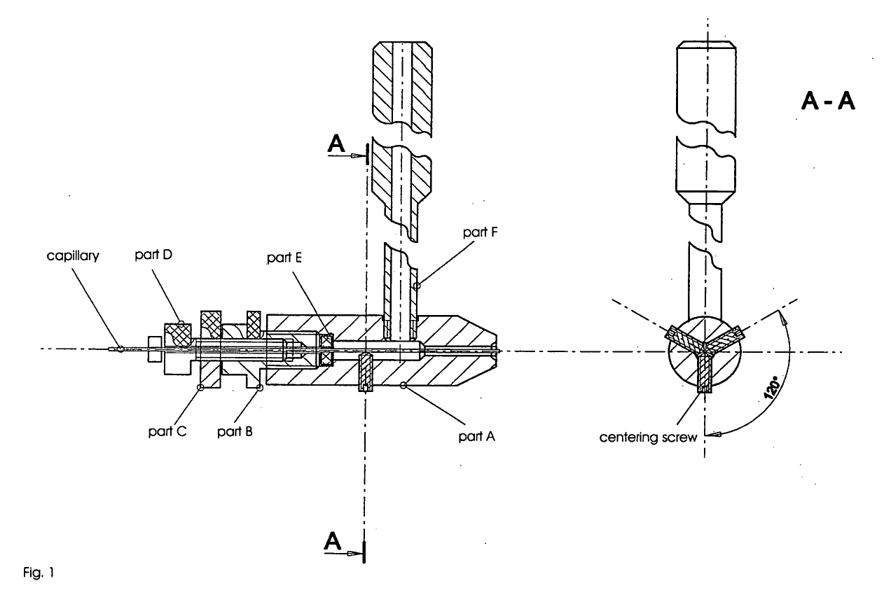

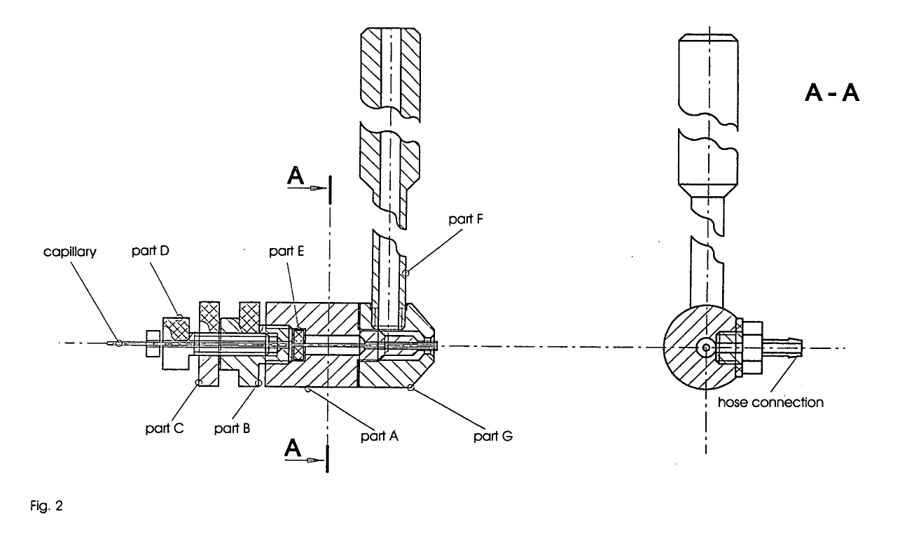

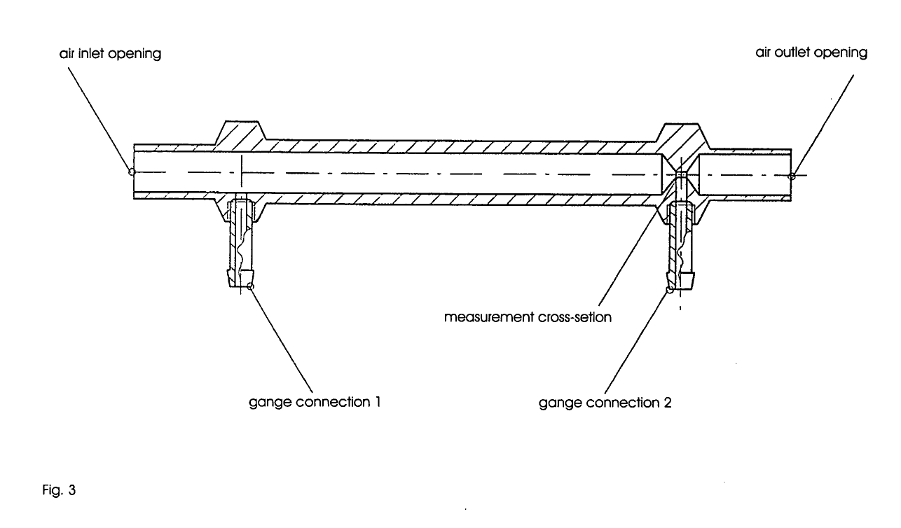

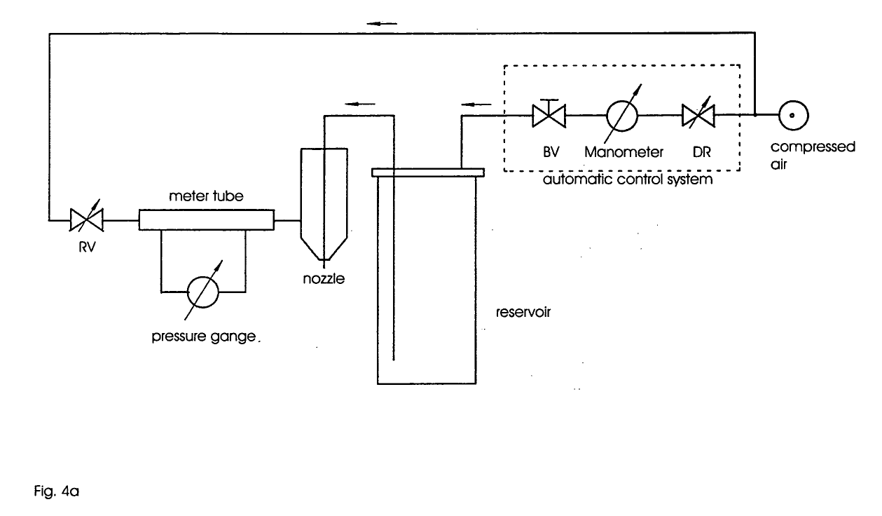

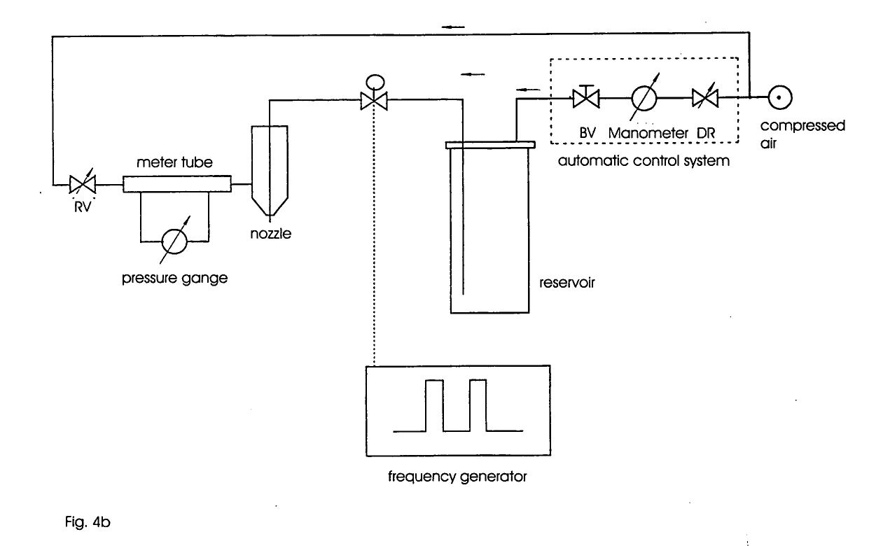

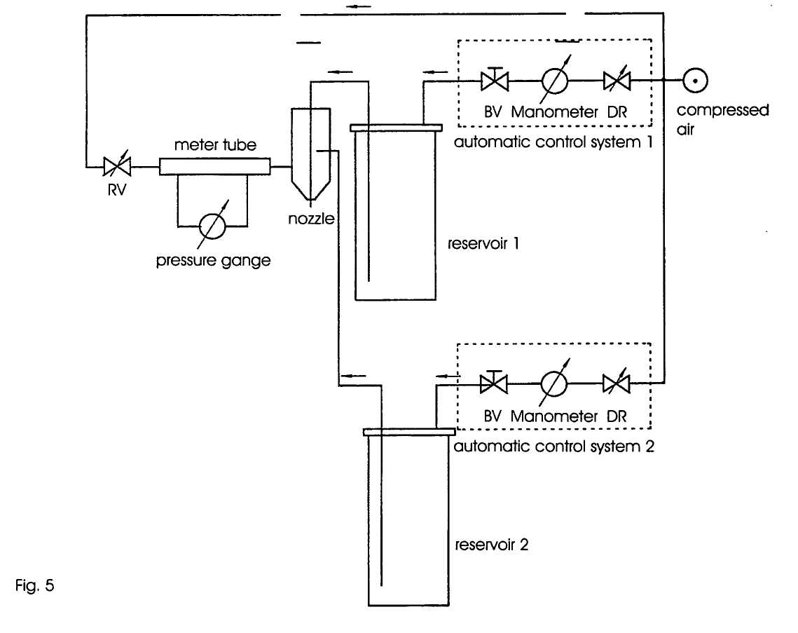

FIG. 1 and FIG. 2 show different types of nozzles all of which can be used in the device with a corresponding periphery. They are made, for example, of special steel, another metal or synthetic materials, which may be machined correspondingly, and/or a combination of metals and synthetic materials. FIG. 4a, FIG. 4b and FIG. 5 show several assemblies of additional components of the device serving the supply of media and the control of the nozzles. FIG. 3 illustrates the meter tube in detail, which measures air flows in the interior of the system.

FIG. 1 shows a so-called two-media nozzle. The operating principle of this nozzle is known from the prior art. However, according to the invention, it was modified to allow an extremely precise adjustment of the central capillary. In this way an extremely narrow size distribution of the droplets is achieved. The nozzle operates as follows: The material to be transformed into droplets is pressed through a centrally arranged capillary, so that a liquid jet is formed at the lower nozzle end. Prior to this, the capillary outlet opening is adjusted relative to the nozzle body (part A) by means of the adjustment screw D and fixed by the locking ring C. A centering of the capillary is accomplished with the three centering screws. If air or another gas is blown via the feeding collar F into the nozzle body the air will escape at the lower nozzle end concentrically to the capillary, as the seal E seals the hollow space inside the nozzle body towards the top. This air flow effects a defined droplet separation, with the size of the droplet having an inverse proportion with respect to the air flow. By unscrewing part B and removing seal E access is obtained to the hollow space inside part A so that the nozzle is easy to clean.

The periphery associated with this nozzle is matched for the nozzle and is shown in FIG. 4a. A reservoir is supplied with pressure by means of an automatic control system comprising a pressure control valve DR, a manometer and a stop valve BV. This container contains the liquid material to be transformed into droplets. Under the influence of the pressure the liquid is pressed through the capillary of the nozzle. The air flow, which controls the separation of the droplets at the capillary, is adjusted by the control valve RV and is measured with the meter tube of FIG. 3. A reduced cross-section in the interior of the meter tube generates a pressure difference which depends on the air flow flowing through the tube. This pressure difference is detected by a differential pressure gauge connected to both connection pieces of the meter tube.

As an alternative to the system described in FIG. 4a, which operates with a continuous liquid jet, the liquid flow coming from the reservoir can also be pulsed, which is shown in FIG. 4b. This is achieved with a valve (normal state open) inserted in the feed line, which is controlled by a frequency generator. In this way a neat droplet separation is obtained with media having an unfavorable surface tension.

The use of the nozzle illustrated in FIG. 2 in the system allows the production of droplets which contain in their interior a second liquid immiscible with the droplets. This operating principle, too, is described in the prior art multiple times. Due to the inventive modifications and the overall structure derived from the nozzle according to FIG. 1 the nozzle is rendered more reliable and flexible. To this end, the nozzle body A according to FIG. 1 was modified to form a tube in its front part, in the interior of which the capillary is mounted. An additional part G was placed about these two concentric tubes (capillary and part A) into which the air controlling the droplet separation in line with FIG. 1 is blown via F. If the first liquid is now pressed through the capillary and the second liquid through the hose connection on part A, droplets are formed on the outlet openings of both concentric tubes having the second liquid in their interior.

To allow the controlling of such a nozzle, the device underlying the present invention has to be expanded as compared with the system described in FIG. 4a by a second pressure tank and a second automatic control system. This new architecture is shown if FIG. 5. The operating principle of the individual parts corresponds to the one according to FIG. 4a.

1. Device for transforming liquids having a different viscosity into individual droplets with interchangeable nozzles, characterized in that the material to be transformed into droplets is pressed by compressed air from at least one container through at least one capillary in the interior of a nozzle and the droplet separation is effected by an air flow passed concentrically to the capillary in the nozzle.

2. Device according to claim 1 operating according to a method according to claim 1, characterized in that it comprises one or more of the following main components:
nozzle
reservoir for the material to be transformed into droplets
automatic control system for supplying the reservoir with compressed air
control elements for controlling the concentric air flow which causes the separation of the droplet in the nozzle.

3. Device according to claim 1, characterized in that it operates in accordance with FIG. 4a and/or its components are arranged and/or connected to each other in accordance with FIG. 4a.

4. Device according to claim 1, characterized in that it operates in accordance with FIG. 4b and/or its components are arranged and/or connected to each other in accordance with FIG. 4b.

5. Device according to claim 1, characterized in that it operates in accordance with FIG. 5 and/or its components are arranged and/or connected to each other in accordance with FIG. 5.

6. Device according to claim 1, characterized in that it comprises a nozzle which operates in accordance with FIG. 1 and/or the components of which are set up, arranged and/or connected to each other in accordance with FIG. 1.

7. Device according to claim 1, characterized in that it comprises a nozzle which operates in accordance with FIG. 2 and/or the components of which are set up, arranged and/or connected to each other in accordance with FIG. 2.

8. Device according to claim 1, characterized in that it comprises a meter tube which operates in accordance with FIG. 3 and/or the components of which are set up, arranged and/or connected to each other in accordance with FIG. 3.

9. Device according to claim 1, characterized in that the produced droplets can be precipitated chemically, e.g. by the influence of salts.

10. Device according to claim 1, characterized in that the produced droplets can be precipitated physically, e.g. by a temperature change.

11. Device according to claim 1, characterized in that the precipitated droplets contain the material to be immobilized.
